(19) United States
(12) Patent Application Publication
(10) Pub. No.: US 2006/0013671 A1
(43) Pub. Date: Jan. 19, 2006

(54) Threaded insert with multi-lobe broach

(76) Inventor: David Lauderbaugh, Cumming, GA (US)

Correspondence Address: David Lauderbaugh;Corrugated Gear & Services, Inc., 100 Anderson Road, Alpharetta, GA, 30004, US

(21) Appl. No.: 10/891,374

(22) Filed: Jul. 14, 2004

(51) Int. Cl. F16B 37/12

(52) U.S. Cl. 411/178

(57) ABSTRACT

A threaded insert having a cylindrical body with an open end, an outer surface, and an internal channel having an inner surface. The threaded insert includes an outer thread on the outer surface for engagement with a piece of machinery and an inner thread on the inner surface for engagement with a threaded fastener. The threaded insert also includes a multi-lobed broach at the open end for receiving a removal tool. The threaded insert also typically includes a closed end opposite the open end. A typical broach includes six lobes.

### TECHNICAL FIELD

The present invention relates to threaded inserts for machinery and, more particularly, relates to a threaded insert with a multi-lobed broach for receiving a removal tool.

### BACKGROUND OF THE INVENTION

Threaded inserts have been used to replace worn or stripped threaded holes in machinery for many years. A threaded insert is a short, hollow cylinder threaded on both sides to permit replacement of the inner thread when it becomes worn or stripped. The outer threads screw into a bolt hole in a piece of machinery, and a bolt screws or other threaded fastener threads into the inner thread. When the inner thread becomes worn or stripped, a removal tool, such as a screwdriver, is employed remove and replace the threaded insert.

Although threaded inserts have been in use for years, conventional threaded inserts include a flat-head screwdriver removal tool socket for removing and replacing the insert. This type of removal tool socket is typically employed because it is easy to cut into the insert. The flat-head screwdriver removal tool socket can itself become stripped, however, which makes the threaded insert difficult to remove. Accordingly, there is an ongoing need for a threaded insert with a removal tool socket that is not susceptible to stripping.

### SUMMARY OF THE INVENTION

The present invention meets the needs described above in a threaded insert with a multi-lobed broach for receiving a removal tool. The multi-lobed broach, such as a six-lobed socket, is not susceptible to being stripped by the removal tool to the same degree as a conventional flat-head screwdriver socket. Although conceptually simple, the need for this improvement in threaded inserts has remained unmet for many years.

Generally described, the invention includes a threaded insert having a cylindrical body with an open end, an outer surface, and an internal channel having an inner surface. The threaded insert includes an outer thread on the outer surface for engagement with a piece of machinery and an inner thread on the inner surface for engagement with a threaded fastener. The threaded insert also includes a multi-lobed broach at the open end for receiving a removal tool. The threaded insert also typically includes a closed end opposite the open end. A typical broach includes six lobes.

The invention may also be practiced as a method for manufacturing a threaded insert including a cylindrical body having an open end, an outer surface, and an internal channel having an inner surface. An outer thread is machined on the outer surface of the cylindrical body for engagement with a piece of machinery. A multi-lobed broach is also machined at the open end of the cylindrical body for receiving a removal tool. After the broach has been formed, an inner thread is machined on the inner surface for engagement with a threaded fastener. Cutting the inner thread after the broach prevents the cutting of the broach from damaging the inner thread.

In view of the foregoing, it will be appreciated that the present invention provides an improved threaded insert. The specific techniques and structures for implementing the threaded insert, and thereby accomplishing the advantages described above, will become apparent from the following detailed description of the embodiments and the appended drawings and claims.

### BRIEF DESCRIPTION OF THE DRAWINGS

FIG. 1 is a side view of an illustrative threaded insert.

FIG. 2 is an end view of the threaded insert.

FIG. 3 is a cross-sectional side view of the threaded insert.

### DETAILED DESCRIPTION OF THE EMBODIMENTS

The present invention may be employed as a threaded insert for virtually any type of machinery that uses threaded fasteners. In particular, the threaded insert is well suited to the corrugated board industry, where it may be used in a variety of applications such as attaching printing, slotting, scoring and cutting dies to rollers or drums. Of course, there are many other applications in the corrugated board and other industries for threaded inserts. For example, it is presently believed that the threaded insert will be particularly useful in the aviation industry and other high-vibration applications in which treaded fasteners are used, such as automobiles, ships, refinery equipment, power plants, and so forth. Nevertheless, is should be understood that the present invention is not limited to any particular industry or application. It should also be understood that threaded inserts can be provided in a variety of lengths, inner diameters, outer diameters, thread specifications and broach designs.

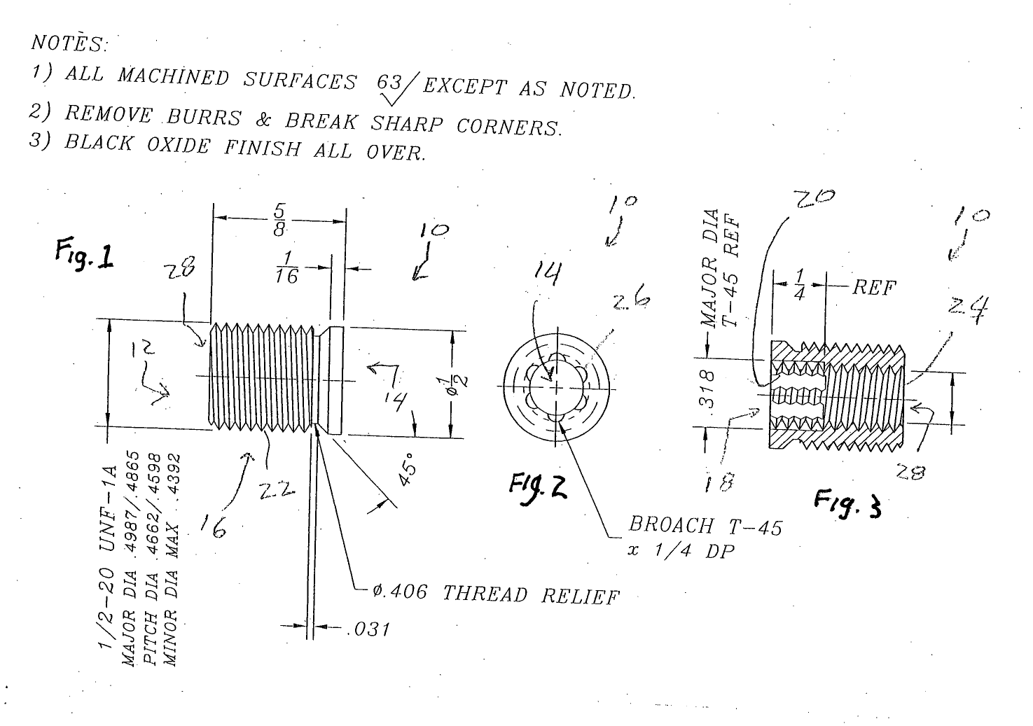

FIG. 1 is a side view of a typical threaded insert 10 showing dimensions and manufacturing specifications of this particular example. FIG. 2 is an end view of the threaded insert, and FIG. 3 is a cross-sectional side view of the threaded insert. As shown in the figures, the threaded insert 10 includes a cylindrical body 12 with an open end 14, an outer surface 16, and an internal channel 18 having an inner surface 20. The insert includes an outer thread 22 on the outer surface for engagement with a piece of machinery and inner thread 24 on the inner surface for engagement with a threaded fastener. The insert also includes a multi-lobed broach 26 at the open end 14 for receiving a removal tool. The insert also typically includes a closed end 28 opposite the open end. The first thread 22 may be self-tapping. A typical broach includes six lobes, as shown in FIG. 2.

The threaded insert 10 is manufactured by cutting or stamping a cylindrical blank, typically from steel. The internal channel 18 is then drilled into the blank. The multi-lobed broach 26 should be cut into the inner surface 20 at the open end 14 of the blank before the inner thread 24 is machined into the inner surface. This prevents damage to the inner thread 24 from the cutting of the broach 26. The threads may be machined into the insert using a milling machine or any other suitable technique.

In view of the foregoing, it will be appreciated that present invention provides significant improvement in threaded inserts. It should be understood that the foregoing relates only to the exemplary embodiments of the present invention, and that numerous changes may be made therein without departing from the spirit and scope of the invention as defined by the following claims.

The invention claimed is:

1. A threaded insert, comprising:
a cylindrical body having an open end, an outer surface, and an internal channel having an inner surface;
an outer thread on the outer surface for engagement with a piece of machinery;
a inner thread on the inner surface for engagement with a threaded fastener; and
a multi-lobed broach at the open end for receiving a removal tool.

2. The threaded insert of claim 1, further comprising a closed end opposite the open end.

3. The threaded insert of claim 1, wherein the broach includes six lobes.

4. A method for manufacturing a threaded insert, comprising the steps of:
fabricating a cylindrical body having an open end, an outer surface, and internal channel having an inner surface;
machining a first thread on the outer surface for engagement with a piece of machinery; and
machining a multi-lobed broach at the open end for receiving a removal tool and then machining a second thread on the outer surface for engagement with a threaded fastener.

5. The method of claim 4, further comprising the step of configuring the threaded insert to include a closed end opposite the open end.

6. The method of claim 4, further comprising the step of configuring the threaded insert to include broach having six lobes.
